(19) United States
(12) Patent Application Publication
(10) Pub. No.: US 2025/0150011 A1
(43) Pub. Date: May 8, 2025

(54) CONTROL DEVICE FOR A PERMANENT-MAGNET SYNCHRONOUS THREE-PHASE ROTATING MACHINE

(71) Applicant: SAFRAN ELECTRICAL & POWER, BLAGNAC CEDEX (FR)

(72) Inventors: Etienne ANNEE, MOISSY-CRAMAYEL (FR); Jérémy CUENOT, MOISSY-CRAMAYEL (FR); Valentin Antoine Maxime MESNIL, MOISSY-CRAMAYEL (FR)

(21) Appl. No.: 18/865,640

(22) PCT Filed: May 17, 2023
(86) PCT No.: PCT/FR2023/050708

§ 371 Date: Nov. 13, 2024

(30) Foreign Application Priority Data
May 18, 2022 (FR) 2204708

(51) Int. Cl. H02P 21/18; B64D 27/30; B64D 31/16; H02P 21/22

(52) U.S. Cl. CPC H02P 21/18; B64D 27/30; B64D 31/16; H02P 21/22; H02P 2207/05

(57) ABSTRACT

A permanent-magnet synchronous three-phase rotating machine equipped with a control device having a command processor for an inverter driving phases of said machine, an angular speed and position estimator module for the rotor of the machine equipped at the input thereof with an input selector module, receiving digital voltage data, where said input selector module is driven by an operating mode command for said machine to select input data for the angular speed and position estimator module of the machine.

### FIELD OF THE INVENTION

The invention relates to the field of command systems for permanent-magnet synchronous three-phase rotating machines such as brushless motors, in particular permanent-magnet synchronous motors driven by a command with at least three phases such as known under the acronym PMSM and relating more specifically to a method and a command device for such a motor without position and speed sensors.

### DESCRIPTION OF RELATED ART

Sensorless control methods and devices for rotating machines or electric motors are known for driving applications at relatively high speed and low resistive load at startup.

Sensorless commands are in particular effective in stable regime, but comprise weaknesses in certain operating modes:
a.—In free-rotation phase, also called free-wheeling, a sensorless command cannot estimate the angular position of the rotor because there is no voltage applied to the synchronous machine by the inverter;
b.—In low-speed or startup phase, the sensorless algorithms have weaknesses with risks of instability and erroneous information.

A second position estimation or measurement system therefore needs to be used for these modes:

For free rotation, such a second system is most often based on a PLL circuit with which to recalculate speed and angle from measurements of electromotive force (EMF) voltages coming from the motor.

For low speed, another solution is to combine a command based on measurement of the electromotive force with a sensorless method using the projection of the machine (position extracted from Ld different than Lq by frequency injection) or else to use a position sensor or even to use an open loop command.

### Technical Problem

Solutions from the state-of-the-art thus require distinct systems to redo the bulk of the estimate or the measurement of the position during mode changes “commanded motor”/“free-rotation motor”/“low speed” and requires managing the transitions between these modes. These transitions involve non-negligible times for resumption of the control and transients caused by the need for convergence of each of the systems at the mode change.

This phenomenon can be seen in the control system (exceeding latency time in the response to an order from the driver). Hence in the case of motor systems used for electrical propulsion, in some phases of flight, in particular descent and cruising, the motor control must respond to frequent mode changes, commanded motor mode and free-rotation motor mode, and the known solutions do not serve to continuously manage these mode changes. Similarly in the case of a braking type mode by short-circuit of the phases of the synchronous machine, the measurement can no longer consider the command or measured voltages.

The field of application relates in particular to rotating machines or motors of several tens of kilowatts to hundreds of kilowatts with several pairs of poles for the control of the rotation thereof. An additional problem is that in the case of a motor with 10 electrical sectors over 360° of the motor shaft, the 10 sectors are themselves subdivided into 360° electrical which demands an angular precision much greater than the mechanical precision of an optical or other sensor.

### BRIEF SUMMARY OF THE INVENTION

In light of the prior art, the present disclosure relates to a control device for the rotation of a permanent-magnet synchronous rotating machine, or brushless motor, and a method for estimating the angular position of the rotor of such a machine providing availability of the position information of this rotor under all operating modes of the machine and the inverter driving this machine, doing so without loss of information at transitions between modes. The control device according to the invention then behaves like a device provided with a virtual position sensor.

To do this, the present disclosure more specifically proposes a permanent-magnet synchronous three-phase rotating machine equipped with a control device comprising a command processor for an inverter driving phases of said machine, for which said processor comprises a angular speed and position estimator module for the rotor of said machine equipped at the input thereof with an input selector module, receiving digital voltage data, where said input selector module is driven by an operating mode command (SEL) for said machine, and where said input selector module is configured for selecting:
a.—inputs for data representative of three-phase command voltages Va_cmd, Vb_cmd, Vc_cmd for phases A, B, C from the inverter, in powered operating mode of said machine;
b.—inputs for data representative of three-phase measured voltages Va_mes, Vb_mes, Vc_mes for phases A, B, C of said machine, in free-rotation mode;
c.—inputs for voltage data forced to zero in short-circuit mode of the phases of said machine;
   as input data for the angular speed and position estimator module of said machine.

With this input selector device, the same algorithm for estimation of the electrical position can be used during the three operating modes and the activation and convergence of a new estimator can thus be avoided during transitions between modes.

The characteristics disclosed in the following paragraphs correspond to embodiments which may be implemented independently of each other or in combination with each other:

The data representative of measured voltages are advantageously two-phase voltage type data Vα1 and Vβ1 from a two-phase model in a stator reference frame calculated by means of a second Clarke transform starting with measured voltages Va_mes, Vb_mes, Vc_mes.

The use of a two-phase reference frame simplifies the calculations.

The angular speed and position estimator module may comprise a phase-locked loop function for getting a convergence of the calculations.

This module may further comprise:
a. an inverse Park matrix P(−θ) module receiving on input, in addition to the voltage data coming from the selector module, current data Iα and Iβ calculated from the currents Ia, Ib, Ic for the phases of said machine by means of a third Clarke transform, where said inverse Park matrix submodule supplies voltages Vδ, Vγ and currents Iδ, Iγ in a δ, γ rotor rotating reference frame for estimation;
b. a counter-electromotive force estimator module EMF EST giving counter-electromotive force values Eδ, Eγ in said rotating reference frame for estimation;
c. a speed estimator submodule SP EST having as output data an estimated speed, looped back on the counterelectromotive force estimator submodule EMF EST, and an angle estimator submodule ANGLE EST, where said speed and angle estimator module has an estimated speed SE and an estimated angle AE of the rotor of said machine as output data.

the estimated angle AE is distributed in a first mathematical function module calculating:

on the one hand, a correction current Iγ1_{fb} from the currents Ia, Ib, Ic measured at the output of the inverter, where said current Iγ1_{fb} is received at a second input of a first comparator receiving at its first input a calculated current for setting Iγ1_{c}, where said first comparator is placed as input to a first current Iγ control module whose output is located at the input to a second mathematical function module for calculation of the command voltages Va_cmd, Vb_cmd, Vc_cmd of the inverter; and on the other hand, a correction current Iδ1_{fb} from the currents Ia, Ib, Ic measured at the output of the inverter, where said current Iδ1_{fb} is received at a second input of a third comparator receiving at its first input a calculated current for setting Iδ1_{c}, where said third comparator is placed as input to a second current control module whose output is located at the input to a second mathematical function module for calculation of the command voltages Va_cmd, Vb_cmd, Vc_cmd of the inverter.

The estimated speed SE may be transmitted to a second input of a second comparator, at the input to the speed controller module, where the first input of said second comparator is a speed setting SC and said speed controller module is connected to an operating point calculation module providing said setting currents Iγ1_{C} and Iδ1_{c}.

The voltage data Vα2 and Vβ2 preferably come from the second mathematical function module.

Said data representative of command voltages are advantageously two-phase voltage type data Vα2 and Vβ2 from a two-phase model in a stator reference frame corresponding to a first Clarke transform of the three-phase command voltages Va_cmd, Vb_cmd, Vc_cmd.

There again, the calculations can be simplified with a two-phase reference frame.

The present disclosure further proposes a method for estimating the electrical position of a three-phase permanent magnet synchronous rotating machine, commanded by a control device described above which comprises selecting voltage input data as a function of the operating mode of said machine among:
a. the command voltages of said machine such as applied by an inverter driving said machine in motor operation;
b. the phase-phase voltages of the stator measured on output from the inverter in free-wheeling mode of the inverter, where said voltages are representative of the counter-electromotive force of said machine;
c. zero voltages in operating mode with short-circuits applied to the phases of the machine by the inverter in braking mode of the machine;
said selection providing voltage data for said machine for an estimated angle AE and estimated speed SE calculation algorithm in said angular speed and position estimator module of said machine.

Using the method, the electrical position (Pos_elec_est) of the three-phase permanent-magnet motor or rotating machine (PMSM) can in particular be estimated from the Counter-Electromotive Force (CEMF), in free-rotating mode, with a method for extraction of the electrical position from the CEMF (also known as BEMF based position estimation).

Advantageously said calculation algorithm is a phase-locked loop type algorithm.

Said estimated angle AE and said estimated speed SE are advantageously used as data for correction of rotation speed calculations of the synchronous machine and for calculations of current and voltage for driving said inverter driving the phases of said machine in said control device.

The driving of the motor may be done by speed or torque.

According to another aspect, a computer program is proposed comprising instructions for implementing all or part of the method as defined herein when this program is executed by a processor.

According to another aspect of the invention, a computer-readable, nonvolatile recording medium is proposed on which such a program is recorded.

### BRIEF DESCRIPTION OF THE DRAWINGS

Other characteristics, details and advantages of the invention will appear upon reading the following detailed description of nonlimiting implementation examples, and analyzing the attached drawings, on which:

FIG. 1 shows a schematic view of a sample speed command system for a brushless synchronous motor according to the present disclosure;

FIG. 2 shows a sample implementation of a selection module and an angular speed and position estimator applicable to the invention;

FIG. 3 shows a schematic view of a sample torque command system for a brushless synchronous motor according to the present disclosure.

### DETAILED DESCRIPTION OF THE INVENTION

The following drawings and description contain items which may not only serve to make the present invention better understood, but also contribute to the definition thereof, as applicable.

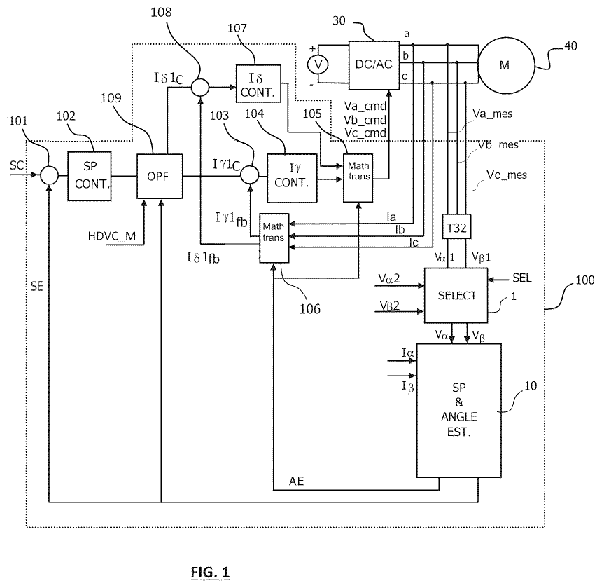

The present disclosure relates to a control device for a permanent-magnet synchronous machine with at least three phases, also called permanent-magnet brushless synchronous electric motor, driven by a command to at least three phases abbreviated here by “motor,” and a method for estimation of the position of the rotor of the synchronous machine as shown in FIG. 1, where the device is suited for selecting measurement paths so as to implement a virtual position sensor. The device and the method are incorporated in an electronic control chain for an inverter 30 powering the machine. The method is advantageously implemented in a processor 100 of the control electronics for the inverter.

The machines involved are electrical machines from several tens of kilowatts to several hundreds of kilowatts comprising several pairs of poles which require knowledge of the electrical angle over 360° to control them. For example, for 10 sectors which electrically make 360°, the necessary precision is much greater than the precision of the mechanical rotation angle of the machine.

The system according to FIG. 1, corresponds to a speed command of the motor, and is made up in the first place of a set of physical components:
a. a permanent-magnet synchronous machine 40;
b. an inverter 30 generating three-phase voltages for command of the machine;
c. an electronic control 100 hosting command software for the inverter for generating voltages and currents for driving the machine;
d. a set of current Ia, Ib, Ic and voltage sensors Va_mes, Vb_mes, Vc_mes on the phases a, b, c connecting the inverter to the machine.

The system comprises input data coming, for example, from a flight processor and which provides a speed setting SC and a selection command SEL as data for a selection module, as will be seen below.

The system further comprises, in the software for driving the machine, an algorithm for determining the position of the rotor according to the method of the present disclosure for generating the command voltages of the machine in the inverter in the operating modes of the machine, including a high-impedance mode according to which the inverter does not apply voltages to said phases and a short circuit mode in which the inverter short-circuits at least some of the phases of the machine.

In the case of a permanent-magnet synchronous three-phase rotating machine, for propulsion of an aircraft, the method for determination of the position of the rotor of the machine 40 is used in all flight phases. Without being exhaustive, we can list among these phases:
a. Take off,
b. Cruising,
c. Descent,
d. Free rotation, called “windmilling”.

The method for determination of the position of a rotor of a synchronous machine from the present disclosure requires input data, as a function of the operating modes of the synchronous machine, acquisition of transient currents Ia, Ib, Ic between the inverter and the machine, inverter output voltages Va_mes, Vb_mes, Vc_mes and the acquisition of command voltages from the inverter Va_cmd, Vb_cmd, Vc_cmd and on output provides electrical angular position AE and speed SE information for the rotor for the conventional control algorithms of the machine such as driving the supply current or driving the rotation speed.

FIG. 1 proposes a control device for the inverter 30 for driving the synchronous machine 40 by speed, which comprises a processor 100 for driving the phases of the inverter supplying the synchronous machine.

More precisely, the control electronics comprise according to FIG. 1 several functional blocks implemented in a command processor, where these functional blocks comprise a speed controller SP CONT 102, a first current controller Iγ CONT 104, a second current control module Iδ CONT 107, where the output of these current controllers is connected to a first T32 type+rotation mathematical transformation module 105 of with which to generate the command voltages Va_cmd, Vb_cmd and Vc_cmd that the inverter must apply to the motor and to transform these command voltages Va_cmd, Vb_cmd and Vc_cmd into command voltages Vα2 and Vβ2 in a two-phase stator α-β rotating reference frame, a block for speed and angle estimation SP & ANGLE EST 10 which is going to give the speed SE and angle AE estimates used in the feedback loops for said speed and current controllers.

The algorithm corresponding to the speed estimation algorithm block comprises an estimation loop for the machine EMF that can operate either on the basis of:
a. the three-phase voltages applied by the inverter in active clipping in sensorless regulation operation (sensorless mode) in motor or generator mode;
b. the measurements of the phase-neutral voltages Va_mes, Vb_mes and Vc_mes of the stator in free-rotation mode with the inverter in open-circuit mode;
c. the voltages Va, Vb, Vc set to zero in case of active short-circuiting by the inverter;
d. the voltages applied by the inverter in regulation operation with a position sensor insufficient for driving but sufficient in motor or generator mode for managing the startup phases;
e. the voltages applied by the inverter Va_cmd, Vb_cmd, Vc_cmd in open-loop regulation operation with position information (start up in acceleration ramp).

The generator mode corresponds to a compatible control of the braking for which there is a negative torque with a positive velocity.

The method comprises two major blocks:

A block 1 for selection of the voltage information for the motor phases received through different channels: voltages Vα2 and Vβ2 coming from control voltages Va_cmd, Vb_cmd and Vc_cmd, voltages Vα1 and Vβ1 coming from voltage measurement Va_mes, Vb_mes and Vc_mes or even voltages Vα0=Vβ0 forced to zero and this is done according to the operating modes.

This selection block is commanded by the SEL command coming from the flight processor not shown, where this command is representative of the operating mode of the inverter driven for its part by a command SEL′.

The angular speed and position estimator SP&ANGLE EST 10 of the motor uses the “current/voltage” information with the voltages selected in the selection module and the current values on the phases when the inverter drives the phases, the voltages measured on the motor phases in free-wheeling mode or the currents of the phases solely in short-circuit mode of the phases.

For the processing the “current/voltage” information portion, the sensorless method requires continuously knowing the voltages applied to the motor and the currents injected in the motor.

As seen above, in the case of a command by the inverter, the voltages are advantageously the command voltages from the inverter Va_cmd, Vb_cmd, Vc_cmd for which the measurement is not affected by clipping of the voltage created by the inverter.

In fact, in case of active command of the inverter, the measurement of the voltages of the motor phases is difficult to implement because the applied voltage is modulated at high frequency by the clipping of the inverter.

In the case of free rotation for which the command from the inverter is high impedance, the solution is to use the voltage measurements Va_mes, Vb_mes and Vc_mes. In this operating mode, the pulse width modulation command of the motor no longer works, the commander voltages are no longer available, and the machine CEMF voltages are therefore directly available.

In the short-circuit case, when the inverter applies a short circuit to the motor, the voltages considered by the estimator are not measured, but are forced to Va=Vb=Vc=0 V.

In this operating mode, the MLI command for the motor no longer works either, only the currents in the phases are measured.

The solution from the present disclosure is thus to select the voltage inputs in the logical or physical selection module 1 as a function of the operating mode of the inverter defined with the following logic:

```
{
If the motor is in short-circuit (SC_cmd=1), then the
input voltages are zero (0 V).
Else
  If the motor is in open circuit
  (OC_cmd=1).
  then the measured voltages are used
  (Va_mes, Vb_mes and Vc_mes).
  Else, the command voltages are used
  (Va_cmd, Vb_cmd and Vc_cmd).
}
```

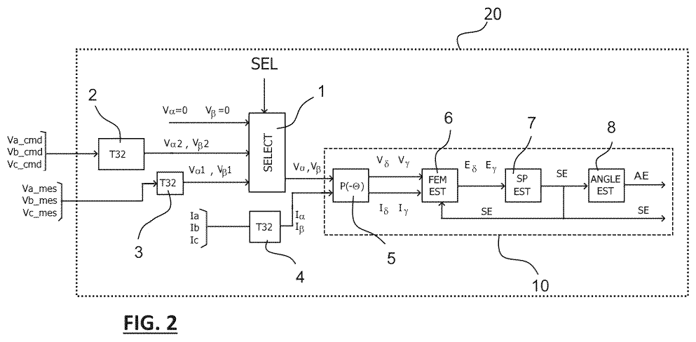

In the embodiment shown more specifically in FIG. 2, pre-processing is done on the three-phase voltages to transform them into two-phase voltages with Clarke transform software modules, also called Concordia transforms, T32, transform 3 for transforming the voltages Va_mes, Vb_mes and Vc_mes into two-phase voltages Vα1, Vβ1 in a reference frame bound to the stator, and transform 2 for the voltages Va_cmd, Vb_cmd, Vc_cmd to give the voltages Vα2, Vβ2 in said reference frame bound to the stator. It is then two-phase voltages which are used in the selection module 1 for supplying the angular speed and position estimator module 10 voltages Vα, Vβ with which to calculate the estimated speed and estimated angle of the motor.

The currents are processed in the same way by a Clark T32 transform 4 in order to have currents Iα, Iβ and voltages Vα, Vβ be in the same reference frame.

The angular speed and position estimator module 10 comprises in the first place an inverse Park matrix module 5, symbolized P(−θ), which transforms the voltages Vα, Vβ and currents Iα, Iβ from the stator reference frame into voltages Vδ, Vγ and currents Iδ, Iγ in a reference frame bound to the rotor.

These voltages and currents are used as input data to an electromotive force estimation module (or counter-electromotive force according to the machine-side or inverter-side reference frame selected) of the machine in a phase-locked loop (PLL) type loop comprising an estimated speed calculation module SE whose output is reintroduced into the electromotive force estimation module.

The interest in the device is to have position information for the rotor in the three main operating modes of the three-phase inverter: pulse width modulation PWM mode, open-circuit mode (free-wheeling) and short-circuit mode seen from the machine according to the instruction given by the flight processor in the SEL′ command. With this solution, the same estimation algorithm for the electrical position can be retained during these three operating modes.

Processor 100 comprises an angular speed and position estimator module 10 of the synchronous machine provided at the input thereof with an input selector module 1 receiving digital voltage data. Said input selector module is driven by the motor operating mode selection command SEL, for example coming from a propulsion motor management processor of an aircraft or other.

The input selector module 1 receives:
a. voltage data inputs Vα2 and Vβ2 from a two-phase model in a stator reference frame corresponding to a first Clarke transform 2 of the three-phase calculated command voltages Va_cmd, Vb_cmd, Vc_cmd for the phases A, B, C of the inverter 30, in powered operating mode of said machine;
b. voltage data inputs Vα1 and Vβ1 from the two-phase model in the stator reference frame calculated using a second Clarke transform 3 from the measured three-phase voltages Vα_mes, Vb_mes, Vc_mes of the phases A, B, C of said machine, in free-rotation mode of the motor;
c. voltage data inputs Vα0 and Vβ0 from the two-phase model forced to zero in short-circuit mode of the phases of said machine;
   The data corresponding to the operating mode of the motor are sent as input data to the angular speed and position estimator module 10.

In FIG. 1, the data Vα2 and Vβ2 from the two-phase model in the stator reference frame and corresponding to the calculated command voltages come from the mathematical transform module 105 which also provides the voltages Va_cmd, Vb_cmd, Vc_cmd.

Returning to FIG. 2, the angular speed and position estimator module 10 comprises a phase-locked loop (PLL) function.

This estimator module comprises an inverse Park matrix P(−θ) module 5 which receives as input, in addition to the voltage data coming from the selector module, current data Iα and Iβ calculated from the currents Ia, Ib, Ic for the phases of said machine by means of a third Clarke transform 4. This inverse Park matrix submodule supplies voltages Vδ, Vγ and currents Iδ, Iγ in a δ-γ rotating reference frame for estimation bound to the rotor of the synchronous machine.

The estimator module 10 comprises an electromotive force estimator module CEMF EST 6 which calculates counter-electromotive force values Eδ, Eγ in said rotating reference frame for estimation.

The estimator module 10 next comprises a speed estimator submodule SP EST 7 whose output data is an estimated speed SE.

To implement the phase-locked loop, the estimated speed SE is reintroduced as correction data in the electromotive force estimator submodule EMF EST 6.

Finally, the estimator module 10 comprises an angle estimator submodule ANGLE EST 8.

The output data from the speed and angle estimator module 10 are an estimated speed SE and an estimated angle AE of the rotor of said machine.

Returning to FIG. 1, the estimated angle AE serves to calculate a correction current Iδ1_{fb} based on the currents Ia, Ib, Ic measured on output from the inverter and calculate currents Iα and Iβ in a first T32 mathematical function module+Math Trans rotational transform 106. This correction current Iδ1_{fb} and a setting current Iγ1_{C} are compared in the first comparator 103. The result of the comparison is sent to the input of a first current Iγ control module CONT 104. The output of this module and the output of the second current Iδ1 control module CONT 107 are used as input to a T32 type mathematical transformation module 105+rotation transform also having the estimated angle AE as input and which is going to generate the three-phase command voltages Va_cmd, Vb_cmd, Vc_cmd and their two-phase transforms Vα2 and Vβ2.

In this example, the two-phase Vα2 and Vβ2 voltages are sent to the selection module 1.

The estimated speed SE coming from the angular speed and position estimator module 10 is sent to a second input of the second comparator 101 as input of a speed controller module 102 which is sent to an OPF (Operating Point Function) module 109 for operating point calculation which also receives the continuous voltage measurement HDVC_M from the supply line of the inverter. This module provides the setting currents Iδ1_{C} and Iγ1_{C}. The calculated setting current Iγ1_{C} is sent to a first input of the first comparator 103 previously seen and the calculated current Iδ1_{C} is sent to a third comparator 108.

From the estimated angle AE and the phase currents, the Math Trans transform module 106 also provides the correction current Iδ1_{fb} for the two-phase rotor reference frame which is going to be compared with the setting current Iδ1_{C} in a third comparator 108 whose output is sent as input to the second current control module Iδ CONT. 107.

Aside from analog/digital conversions of the voltage and current signals measured on the phases between the inverter and the synchronous machine, the calculations and transformations are preferably done by software in the processor 100, for example microcontroller type, which to do this conventionally comprises analog and digital inputs/outputs, analog/digital and possibly digital/analog converters, one or more digital outputs, for example for command signals for the converter 30, program memory, read-only or reprogrammable memory, data memory in particular read-write memory, a clock and various components necessary for operation thereof.

The present disclosure further relates to a method for estimating the electrical position of a three-phase permanent-magnet synchronous rotating machine 40 implemented in the processor 100 and which comprises selecting voltage input data as a function of the operating mode of said machine among:
a. The command voltages of said machine such as applied by the inverter 30 driving said machine in motor operation;
b. The phase-neutral voltages of the stator measured on output from the inverter 30 in free-wheeling mode of the inverter, where said voltages are representative of the counter-electromotive force of said machine;
c. Zero voltages in operating mode with short-circuits applied to the phases of the machine 40 by the inverter 30 in braking mode of the machine;
   said selection providing voltage data for an estimated angle AE and estimated speed SE of said machine calculation algorithm.
   This method is implemented in the processor 100 which constitutes, with its program for implementation of the method, the device of the present disclosure.

The estimated angle AE and estimated speed SE calculation algorithm may in particular be a phase-locked loop (PLL) type algorithm.

In the example, said estimated angle AE and said estimated speed SE are used as correction data for rotation speed calculations of the synchronous machine and for driving current and voltage calculations for a supply inverter for said machine.

Using the method from the present disclosure, the electrical position (Pos_elec_est) of the three-phase permanent-magnet motor or rotating machine (PMSM) can in particular be estimated from the Counter-Electromotive Force (CEMF), in free-rotating mode, with a method for extraction of the electrical position from the CEMF (also known as BEMF based position estimation). Such a method is known for example from the document N. Matsui and Shigyo. “Brushless DC motor without position and speed sensors,” IEEE Trans. on Ind. Applications, vol. 28, no. 1, pp. 120-127, January/February 1992. The use of the CEMF is possible for synchronous machines which turn at high speed and therefore provide a high CEMF.

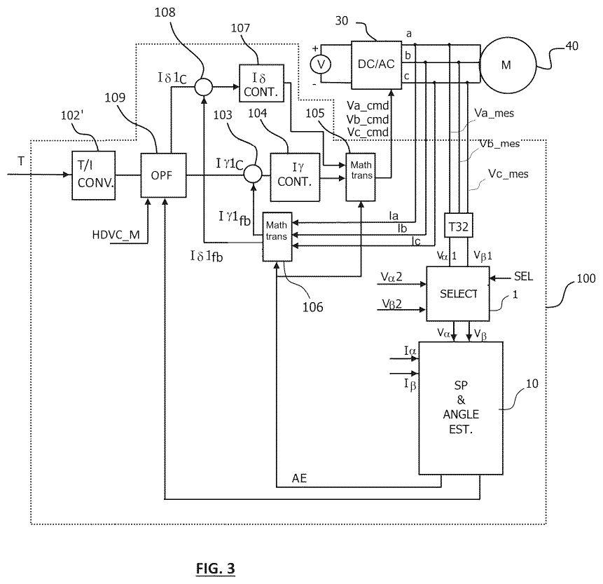

FIG. 3 corresponds to a variant for which the motor is commanded in torque and in this case the device comprises a torque/current transformation module 110 at the input of the operating point calculation module 109 which also receives the measure of continuous voltage measure from the supply line of the inverter for calculating the setting currents.

### INDUSTRIAL APPLICABILITY

The invention may be applied in particular to synchronous machine systems used in traction or propulsion for land, sea or air vehicles with electric propulsion or for static synchronous machine systems like drive motors for industrial devices.

The invention is not limited to the examples described above, solely as examples, but it encompasses all variants which a person skilled in the art in the scope of the protection sought could conceive, for example the processor may be implemented in several separate parts each provided with a dedicated microcontroller, or be incorporated in the inverter.

1. A permanent-magnet synchronous three-phase rotating machine equipped with a control device comprising a command processor for an inverter driving phases of said machine, wherein said processor comprises a angular speed and position estimator module for the rotor of said machine equipped at the input thereof with an input selector module, receiving digital voltage data, where said input selector module is driven by an operating mode command for said machine, and where said input selector module is configured for selecting:
a.—inputs for data representative of three-phase command voltages Va_cmd, Vb_cmd, Vc_cmd for phases A, B, C from the inverter, in powered operating mode of said machine;
b. inputs for data representative of three-phase measured voltages Va_mes, Vb_mes, Vc_mes for phases A, B, C of said machine, in free-rotation mode; and
c. inputs for voltage data forced to zero in short-circuit mode of the phases of said machine;
as input data for the angular speed and position estimator module of said machine.

2. The permanent-magnet synchronous three-phase rotating machine according to claim 1 wherein said data representative of measured voltages are two-phase voltage type data Vα1 and Vβ1 from a two-phase model in a stator reference frame calculated by means of a second Clarke transform starting with measured voltages Va_mes, Vb_mes, Vc_mes.

3. The permanent-magnet synchronous three-phase rotating machine according to claim 1 wherein the angular speed and position estimator module comprises a phase-locked loop function and comprises:
a. an inverse Park matrix P module receiving on input, in addition to the voltage data coming from the selector module, current data Iα and Iβ calculated from the currents Ia, Ib, Ic for the phases of said machine by means of a third Clarke transform, where said inverse Park matrix submodule supplies voltages Vδ, Vγ and currents Iδ, Iγ in a δ, γ rotating reference frame for estimation;
b. a counter-electromotive force estimator module giving counter-electromotive force values Eδ, Eγ in said rotating reference frame for estimation;
c. a speed estimator submodule having as output data an estimated speed, looped back on the counter-electromotive force estimator submodule, and an angle estimator submodule, where said speed and angle estimator module has an estimated speed SE and an estimated angle AE of the rotor of said machine as output data.

4. The permanent-magnet synchronous three-phase rotating machine according to claim 3 wherein the estimated angle AE is distributed in a first mathematical function module calculating:
on the one hand, a correction current Iγ1_{fb} from the currents Ia, Ib, Ic measured at the output of the inverter, where said current Iγ1_{fb} is received at a second input of a first comparator receiving at its first input a calculated current for setting Iγ1_{c}, where said first comparator is placed as input to a first current Iγ control module whose output is located at the input to a second mathematical function module for calculation of the command voltages Va_cmd, Vb_cmd, Vc_cmd of the inverter; and
on the other hand, a correction current Iδ1fb from the currents Ia, Ib, Ic measured at the output of the inverter, where said current Iδ1fb is received at a second input of a third comparator receiving at its first input a calculated current for setting Iδ1c, where said third comparator is placed as input to a second current control module whose output is located at the input to a second mathematical function module for calculation of the command voltages Va_cmd, Vb_cmd, Vc_cmd of the inverter.

5. The permanent-magnet synchronous three-phase rotating machine according to claim 4 wherein the machine is in speed command and for which the estimated speed SE is transmitted to a second input of a second comparator, at the input to the speed controller module, where the first input of said second comparator is a speed setting SC and said speed controller module is connected to an operating point calculation module providing said setting currents Iγ1_{C} and Iδ1_{c}.

6. The permanent-magnet synchronous three-phase rotating machine according to claim 4 wherein the machine is in torque command and for which the device comprises a torque/current transformation module at the input to an operating point calculation module providing said setting currents Iγ1_{C} and Iδ1_{c}.

7. The permanent-magnet synchronous three-phase rotating machine according to claim 5 wherein the voltage data Vα2 and Vβ2 come from the second mathematical function calculation module.

8. The permanent-magnet synchronous three-phase rotating machine according to claim 1 wherein said data representative of command voltages are two-phase voltage type data Vα2 and Vβ2 from a two-phase model in a stator reference frame corresponding to a first Clarke transform of the three-phase command voltages Va_cmd, Vb_cmd, Vc_cmd.

9. A method for estimating the electrical position of a three-phase permanent magnet synchronous rotating machine, performed by the control device according to claim 1 comprising selecting voltage input data as a function of the operating mode of said machine among:
a. the command voltages of said machine such as applied by an inverter driving said machine in motor operation;
b. the phase-phase voltages of the stator measured on output from the inverter in free-wheeling mode of the inverter, where said voltages are representative of the counter-electromotive force of said machine; and
c. zero voltages in operating mode with short-circuits applied to the phases of the machine by the inverter in braking mode of the machine;
said selection providing voltage data for said machine for an estimated angle AE and estimated speed SE calculation algorithm in said angular speed and position estimator module of said machine.

10. The method for estimating according to claim 9 wherein said calculation algorithm is a phase-locked loop type algorithm.

11. The method for estimating according to claim 9 wherein said estimated angle AE and said estimated speed SE are used as data for correction of rotation speed calculations of the synchronous machine and for calculations of current and voltage for driving said inverter driving the phases of said machine in said control device.

12. The method for estimating according to claim 9 wherein the driving of the motor is done by speed or torque.

13. A non-transitory, computer-readable recording medium storing a computer program comprising instructions, which, when executed by a processor, perform the method of claim 9.

14. (canceled)
